(19) United States
(12) Patent Application Publication
(10) Pub. No.: US 2013/0246524 A1
(43) Pub. Date: Sep. 19, 2013

(54) Sending Event-Triggered Messages and Gifts to Network Users

(71) Applicants: Mikael Berner, Los Altos, CA (US); Kavita Gaitonde, Sunnyvale, CA (US); Edgar Kalns, San Jose, CA (US); Jon Landis, San Jose, CA (US); Kesava Neeli, San Jose, CA (US); Hetal Pandya, Cupertino, CA (US)

(72) Inventors: Mikael Berner, Los Altos, CA (US); Kavita Gaitonde, Sunnyvale, CA (US); Edgar Kalns, San Jose, CA (US); Jon Landis, San Jose, CA (US); Kesava Neeli, San Jose, CA (US); Hetal Pandya, Cupertino, CA (US)

(21) Appl. No.: 13/422,769

(22) Filed: Mar. 16, 2012

(51) Int. Cl. G06F 15/16

(52) U.S. Cl. 709/204

(57) ABSTRACT

Provided is a method for sending event-triggered messages and gifts to network users, the message being generated by a triggering event. In one embodiment, meaningful events that are associated with a social network connection of a user are used as the triggering events. The method may comprise monitoring one or more events associated with one or more user connections in one or more social networks, identifying the events, generating the one or more connection-related actionable items, presenting the one or more connection-related actionable items to the user, receiving a user request to execute the one or more connection related items, and executing the one or more connection-related actionable items. Additionally, the user may be able to purchase one or more gifts and attach the one or more gift cards to messages sent to the one or more connections.

### FIELD

This application relates generally to messaging, and more specifically to computer-implemented systems and methods for sending event-triggered messages and gifts to network users.

### BACKGROUND

A growing number of Internet users have accounts with one or more social networks. Often, a user has a large number of connections within a social network, which makes events associated with these connections difficult to monitor and respond to. The ability to monitor connections and manage relationships may be important to many users. Not being able to prioritize and respond to various events in a timely manner may put the user at risk of missing out on an important update.

None of the existing solutions allow users of social networks to efficiently monitor events associated with their connections and to respond to these events in a timely and efficient manner.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for sending event-triggered messages to network users (also referred to herein as user connections, or, simply, connections), which may be accompanied by electronic gift cards.

In various embodiments, the method for sending event-triggered messages and gifts to network users may comprise monitoring one or more events associated with user connections in one or more social networks, identifying the events associated with the one or more connections, generating one or more connection-related actionable items, presenting the one or more connection-related actionable items to the user, receiving a user request to execute the one or more connection-related actionable items, and executing the one or more connection-related actionable items.

In various exemplary embodiments, the method for sending event-triggered messages and gifts to network users may include purchasing one or more electronic or gifts and attaching the one or more gifts to a message associated with the connection-related actionable item.

In various exemplary embodiments, the events associated with the one or more connections may include a birthday, a marriage, winning a game, joining a user group, receiving a degree, getting promoted, making a purchase, a company anniversary, and so forth.

In further examples, subsystems or devices can be adapted to perform the recited steps. Other features, examples, and embodiments are described below.

### BRIEF DESCRIPTION OF THE DRAWINGS

Embodiments are illustrated by way of example and not limitation in the figures of the accompanying drawings, in which like references indicate similar elements.

FIG. 1 illustrates an exemplary environment for implementing various aspects of methods and systems described herein.

FIG. 2 is a block diagram, illustrating a system for sending event-triggered messages and gifts to network users

FIG. 3 illustrates a method for sending event-triggered messages and gifts to network users.

FIG. 4 is a flow chart detailing a method for sending event-triggered messages and gifts to network users, including purchasing gifts to be attached to the messages.

FIG. 5 shows exemplary layouts illustrating a method for purchasing gifts and attaching the gifts to greetings to be sent to users of social networks.

FIG. 6 illustrates some exemplary presentations on mobile devices.

FIG. 7 is a diagrammatic representation of an example machine in the form of a computer system within which a set of instructions for causing the machine to perform any one or more of the methodologies discussed herein is executed.

### DETAILED DESCRIPTION

Example methods and systems for sending a message to network users are described. For the purpose of explanation, the following description contains numerous specific details. These details are set forth in order to ensure a thorough understanding of the example embodiments. It will be evident, however, to one skilled in the art that the present invention may be practiced without these specific details. While some of the concepts are described in conjunction with specific embodiments, it will be understood that these embodiments are not intended to be limiting.

In this document, the terms “a” or “an” are used, as is common in patent documents, to include one or more than one. Furthermore, the term “or” is used to refer to a nonexclusive “or,” such that “A or B” includes “A but not B,” “B but not A,” and “A and B,” unless otherwise indicated.

The methods and systems proposed herein may allow automatically monitoring events associated with one or more user connections in one or more social networks, including connection-related events of which the user is notified by email or connection-related events in the electronic calendar of the user, notifying the user when the one or more of the connections have a birthday or some other important event, and enabling the user to send one or more birthday wishes or other messages to the one or more connections. In accordance with some embodiments, the one or more birthday wishes or other messages may also be accompanied with one or more gifts. The gifts may be anything that can be ordered electronically, such as electronic gift cards, gifts ordered from online services, etc.

In various exemplary embodiments, the user may be allowed to exercise control over the process of delivery of the one or more birthday wishes and/or other messages and gifts. For example, the user may be allowed the possibility of canceling a delivery of the one or more birthday wishes messages and/or other greetings, messages, and gifts, or to request that a delivery notification be sent to the user when the one or more birthday wishes messages, and/or other greetings, messages, and/or gifts are delivered to the one or more connections.

The one or more birthday wishes messages, and/or other greetings messages and gifts may be delivered to the one or more of the connections via the one or more social networks (for example, they may be displayed on the profile page of the connection in the social network), an email client and electronic calendar. The system may be able to simultaneously work with a plurality of social networks. The user may select from multiple predetermined options of the birthday wishes messages or other greetings messages. In various exemplary embodiments, a text of the birthday wishes message or other greetings message may be modified by the user. The message to network users may include a birthday wish, a greeting, and/or a gift.

The user may be notified about the birthday of the one or more connections, or about some other festive or important event or activity associated with the one or more connections, using the connection-related actionable item that may be collapsible, or otherwise expandable, and which may contain a predetermined message. The predetermined message may contain information concerning the social networks from which the information related to the birthday of the one or more connections (or some other festive or important event or activity) was retrieved. The predetermined message may be replaced with the text of the birthday wishes message or other greetings message on the user screen after the connection-related actionable item is reviewed and/or accepted by the user.

The connection-related actionable item, used to notify the user about the event associated with the connection, may use an image from a profile of the connection in the social network as an icon. The text of a birthday notification that is used to inform the user about the birthday of the connection may comprise two lines, including the first and last names of the connection and the word “birthday.” This information may be displayed next to the icon with the image of the connection.

The one or more connection-related actionable items may be shared by email with one or more recipients. The connection-related actionable items that are emailed may be accompanied with an editable note, which may contain the date and time that the connection-related actionable item was delivered, or is still due to be delivered, to the connection. The default date and time for sending the birthday wishes message or other greetings message may be 9 a.m. of the day of the birthday of the connection. The time parameter may be adjustable, and may be modified by the user.

The sending of the birthday wishes message or other greetings message may be scheduled for a specific date and time. In various exemplary embodiments, the birthday wishes messages or other greetings message scheduled for delivery at a later date, may or may not be rendered editable by the user. In the former case, the text of the message and such details as the date, time, and importance of the message may be rendered editable.

Once it is determined that the due date and time of the birthday wishes message and/or other greetings message is within a predetermined period of time (for example, within a period of five hours preceding the scheduled sending/delivery) the birthday wishes message or other greetings message may automatically be rendered non-editable.

The user may be able to look up the current status of the birthday wishes message or other greetings message. This includes the one or more birthday wishes messages or other greetings messages that are either pending delivery, or have been delivered.

The one or more connection-related actionable items and/or the corresponding birthday wishes messages, and/or other greetings messages may have different statuses in the system. For example, these statuses may include “Proposed” and “Accepted/Scheduled.” The details of the connection-related actionable item may vary depending on the status of the connection-related actionable item. For the connection-related actionable items with the status “Proposed,” the information presented to the user may include parameters of the connection-related actionable items such as the social network from which the connection-related actionable item originates, the level of importance of the connection-related actionable item, and notes/commentary.

For the connection-related actionable items with the status “Accepted/Scheduled,” the information presented to the user may include a delivery date and time of the birthday wishes message or other greetings message, the social network the message will be delivered through (in the case of email, email may be indicated), and payment information (for example, an amount, credit card information, and date of purchase). In addition, it may be possible to include information on whether the gift card associated with the birthday wishes message or other greeting has been purchased already, or whether it is still pending purchase, as well as the delivery (sending) date and time of the gift card. In some embodiments, the connection-related actionable items with the status “Delivered” may be introduced. For the latter, the details may include the payment details, the delivery date, and the channel through which the birthday wishes message or other greetings message and related gift card were delivered (for example, the social network or email). In the same or other embodiments, the source from which the one or more gifts were purchased, or otherwise obtained, may also be indicated.

The user may be able to request a confirmation of receipt that may be displayed to the user on a separate page. The connection-related actionable items that may be collapsible or otherwise expandable may have a varying look and feel and structure depending on the status of the connection-related actionable items.

The events associated with the one or more connections and monitored by the system may include trips, vacations, promotions, or a combination of the above. Correspondingly, in one or more embodiments, the system may be used to create and send wishes of a good trip, a pleasant vacation, or a note of congratulations related to the promotion of the connection. This may be done when the connection publishes information about an upcoming trip through the social network or changes a job title in the profile of the connection in the social network.

The connection-related actionable item associated with the note of congratulations may be generated if the connection publishes via the social network some information about having made a costly and important purchase. Incidentally, a set of predetermined, selectable purchase-related options may be used by the user to enable the system to monitor and identify events of the kind. For example, the user may be able to indicate that the user wants to be notified when the one or more connections have bought a house or a car.

The connection-related actionable item may be generated when the connection publishes information on someone having been married. The connection-related actionable item may be generated when the connection publishes, via the social network, information about having received a degree, or adds the information to the profile of the connection in the social network. In various exemplary embodiments, the methods and systems for sending event-triggered messages and gifts may be used by administrators of corporate groups, or other groups that exist in the social networks, for generating and sending greetings to just-joined members of the above groups. In the same or other embodiments, corporate and freelance recruiters may be enabled to send greetings and thanks to the network users who have just become the connections.

The system may be used to interact with a gaming application that is part of the social network to send the greetings message when the connection has become a winner in a game. The one or more birthday or other greetings messages and gifts pending execution may be cancelled by the user. This may be done by clicking a button (for example, “Cancel”) in the connection-related actionable item, or typing in “Delete” in the connection-related actionable item. The user may be able to receive a cancellation notification.

The events associated with the one or more connections may be monitored and selected for generation of the one or more connection-related actionable items based on search criteria predefined by the user. The system may support multiple languages. The user may be able to set a language of choice for a specific social network, or a specific selection of the connections from the one or more social networks. The one or more connection-related actionable items may contain links to various media (for example, to a video or audio).

The user may be able to create the hierarchy of priorities in accordance with which the one or more connection-related actionable items may be generated. For example, some of the several social networks may have a greater priority. Correspondingly, a range of the events based on which the one or more connection-related actionable items may be generated may be broader for the said social networks than for the rest of the social networks of the user. Different priorities may be set for the different social networks, user groups within the one or more social networks, or a selection of the connections from the one or more social networks.

In some exemplary embodiments, it may be possible to define different priorities for different sources used to generate connection-based actionable items.

The system may be able to identify two or more identical connection-related events retrieved from the one or more social networks to rule out the possibility of generating two or more identical connection-related actionable items. The one or more connection-related actionable items may be generated based on the fact that the user of the social network has commenced following a company in the network. In different example embodiments, the user may be the connection of the administrator of a profile of the company/corporate groups that belong to the company in the social network, while in other embodiments the user may just be a regular user of the social network.

The one or more connection-related actionable items may be generated based on an anniversary of the one or more companies the user is following or the one or more employees to which the user is connected. In this case, multiple connection-related actionable items may be generated for each occasion so that the user will select the more appropriate connection or connections to which the user can send greetings.

The user may be able to set a period of time to precede the execution of the one or more connection-related actionable items and/or sending of the one or more gifts associated with the one or more connection-related actionable items. The multiple connection-related actionable items may be executed contemporaneously. The one or more gifts may be sent to the one or more connections without being attached to the user greetings.

The user may be able to send and receive the user greetings and the one or more gifts associated with the user greetings within/via the system. The one or more gifts may be viewed using a separate gift card-viewing page of the system. The system for sending event-triggered messages and gifts may be a web-based application, or a mobile application.

The system may be able to notify the user about having generated the one or more connection-related actionable items using one or more special widgets, located on the status bar of a user browser. The one or more special widgets may be based on icons of one or more corresponding social networks, which may be implemented as popping and/or blinking widgets.

The one or more connection-related actionable items may be presented to the user in the form of a list with execution (“to do”) buttons next to the one or more connection-related actionable items. The one or more connection-related actionable items may have different widgets located next to the one or more connection-related actionable items. For example, the widgets may comprise alarm widgets that would be intended for notifying the user about the need to react to the connection-related actionable item that has a high level of importance. Other widgets may comprise clock-type widgets that may show an amount of time left before a corresponding connection-related actionable item is executed.

The system may be set to automatically cancel the one or more connection-related actionable items that have not been reacted to by the user within a specified period of time. For example, the user may be able to adjust the system to automatically cancel all the connection-related actionable items with a default delivery/execution date that is five days overdue.

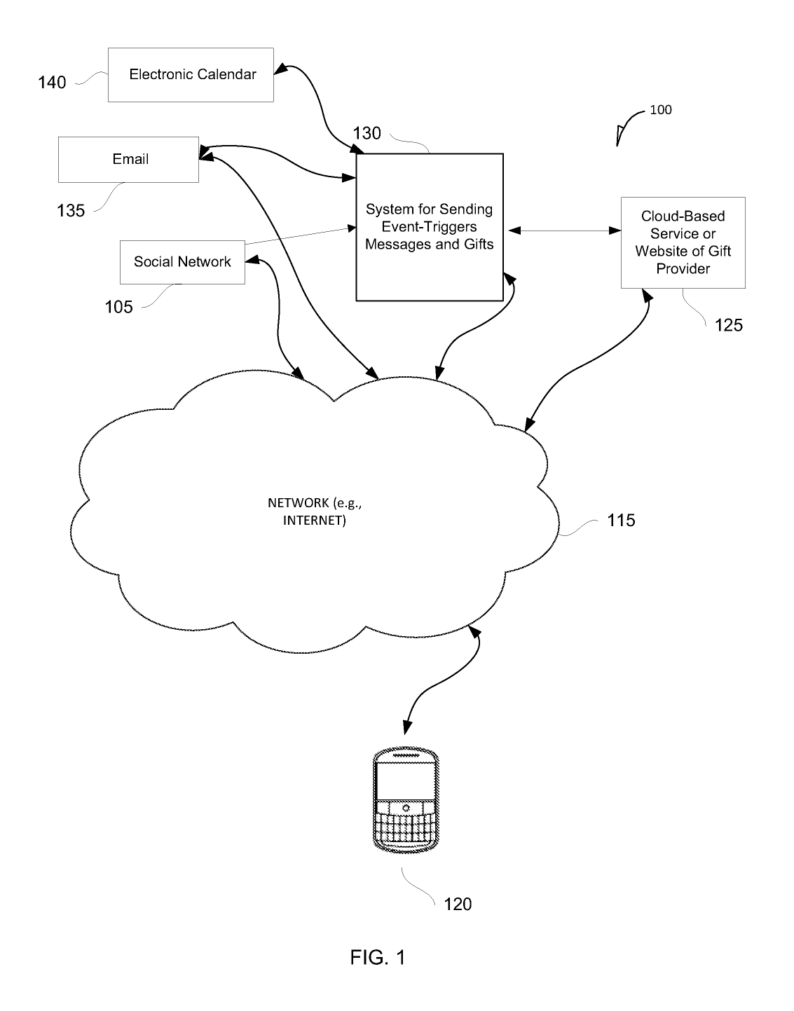

Referring now to the drawings, FIG. 1 illustrates an example network segment 100 for implementing various aspects of methods and systems for sending birthday wishes, other greetings, and gifts to users of social networks, in accordance with various exemplary embodiments. A mobile device of the user 120 may connect the system for sending event-triggered messages and gifts 130 to users of social networks 105 (with the system being a web-based application in the present embodiment) via the network 115, or, in the present embodiment, the Internet. The system for sending event-triggered messages and gifts 130 may be connected via the network 115 to the social network 105, email 135, and calendar 140 that may be monitored to identify which of the events associated with the one or more of the user connections are suitable for generating the one or more connection-related actionable items. The system for sending event-triggered messages and gifts 130 may use the network 115 to connect to a cloud-based service or a website of a gift card provider 125 for purchasing and attaching the one or more gifts, as well as to a mobile device of the user 120, for presenting the one or more connection-related actionable items that have been generated to the user and receiving the user request to execute the one or more connection-related actionable items.

The network 115 may be also used for communication between various components of the payment processing system. The network 115 may assume any suitable form, such as a wide area network (WAN) or the Internet, or one or more local area networks (LANs). The network 115 may include any suitable number and type of devices (e.g., routers and switches) for forwarding commands, content, or web object requests from each client to the online community application, and for sending responses back to the clients.

The methods described herein may also be practiced in a wide variety of network environments (represented by the network 115) including, for example, TCP/IP-based networks, telecommunications networks, wireless networks, and so forth. In addition, the computer program instructions may be stored in any type of computer-readable media. The program may be executed in accordance with a variety of computing models that include a client/server model, a peer-to-peer model, a stand-alone computing device, or in accordance with a distributed computing model, wherein the various functionalities described herein may be implemented or employed at different locations.

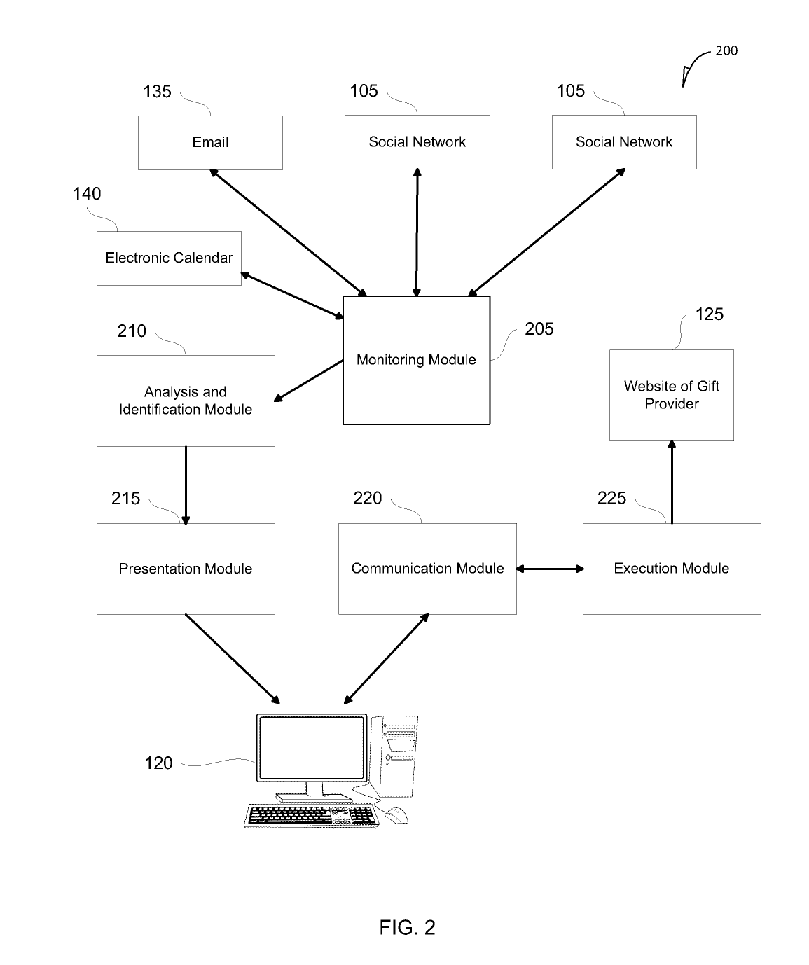

FIG. 2 is a block diagram illustrating the process 200 of sending birthday greetings, other greetings, and gifts to users of social networks, in accordance with various embodiments. The social networks 105 and email 135 may be monitored by the monitoring module 205, conveying information that has been received from the social networks 105 and email 135 to the analysis and identification module 210. The analysis and identification module 210 may identify the one or more events that are suitable for generating the one or more connection-related actionable items and generate the one or more connection-related actionable items. When the one or more connection-related actionable items are generated, the one or more connection-related actionable items may be presented to the user by the presentation module 215. Using the computer system of the user 120, the user may issue a corresponding command to the communication module 220, which may then instruct the execution module 225 to execute the one or more connection-related actionable items, including a purchase of the one or more gifts from the cloud-based service or website of the gift card provider 125 and attachment of the one or more gifts to the messages associated with the one or more connection-related actionable items being executed.

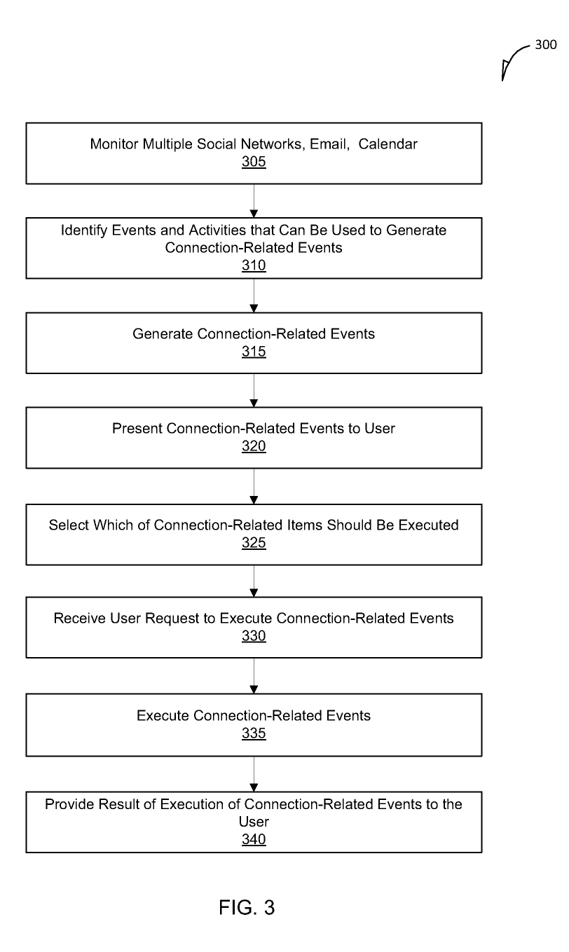

FIG. 3 is a process flow diagram, illustrating the process of sending birthday wishes, other greetings, and gifts to users of social networks, in accordance with various embodiments. The method may commence at operation 305 with the monitoring module 205 contemporaneously monitoring the social network 105, email 135, and calendar 140. The method continues at operation 310, wherein the analysis and identification module 210 may identify the one or more events associated with the user connections in the social network 105, contained in messages delivered to the email 135 of the user, or displayed by the electronic calendar 140 of the user. For example, one event in the electronic calendar 140 of the user may be a birthday, while two user connections in the social network 105 may be employees of a company that is marking a company anniversary and has published some information about the event in the social network 105. The analysis and identification module 210 may generate the three connection-related actionable items at operation 315 and present the three connection-related actionable items to the user at operation 320.

At operation 325, the user may decide which of the three connection-related actionable items that have been presented are to be executed. This may be done by clicking an “Execute” or similar button next to a corresponding selectable option. The method may continue at operation 330 with the communication module 220 of the system receiving the user request to execute the one or more connection-related actionable items that have been selected by the user, which may further be executed by the execution module 225 at operation 335. The process may be finalized by the user being notified about the result of the one or more connection-related actionable items having been executed at operation 340.

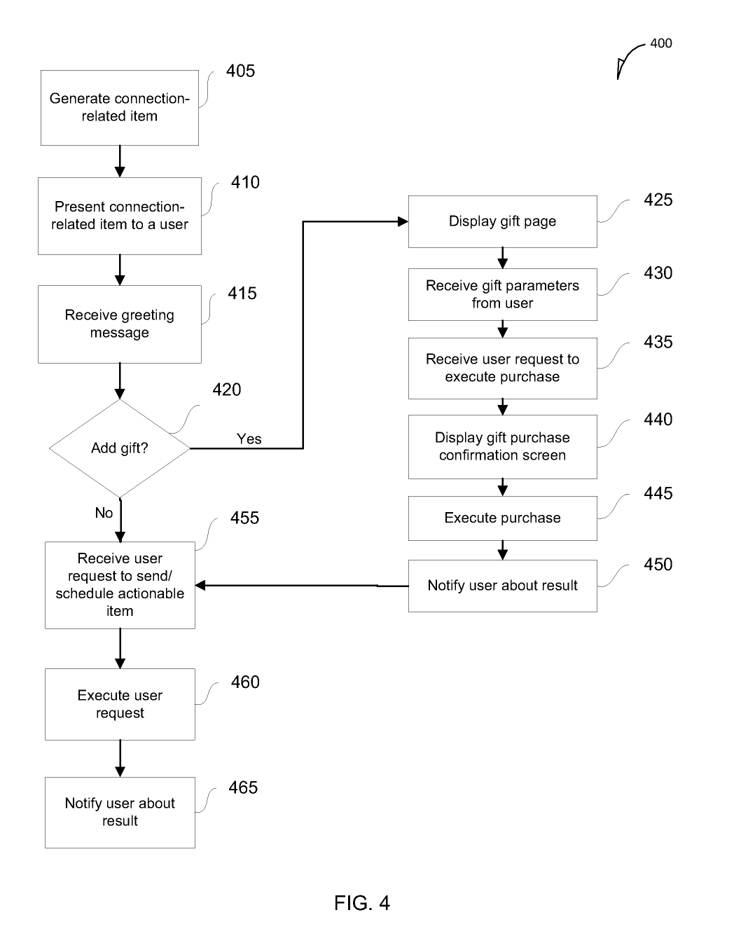

FIG. 4 is a flow chart, detailing a method for sending event-triggered messages and gifts to network users 400. After generating a connection-related actionable item at operation 405, the connection-related actionable item may be presented to the user at operation 410. The user may add the E-gift card at operation 420. If the user chooses to add the Egift card, a page may be displayed at operation 425, and E-gift card parameters may be received from the user at operation 430. At operation 430, an E-gift card purchase confirmation page may be displayed. The method may then proceed with finalizing of the purchase at operation 445, notifying the user about results at operation 450, and receiving a user request to execute or schedule the connection-related actionable item at operation 455.

When the user does not wish to add the E-gift card, the method 400 may proceed from operation 420 to operation 455 by either executing the connection-related actionable item or scheduling the connection-related actionable item for delivery if the connection-related actionable item refers to a future event or activity.

The connection-related actionable item may be executed at operation 460 and the user may be notified about the execution results at operation 460.

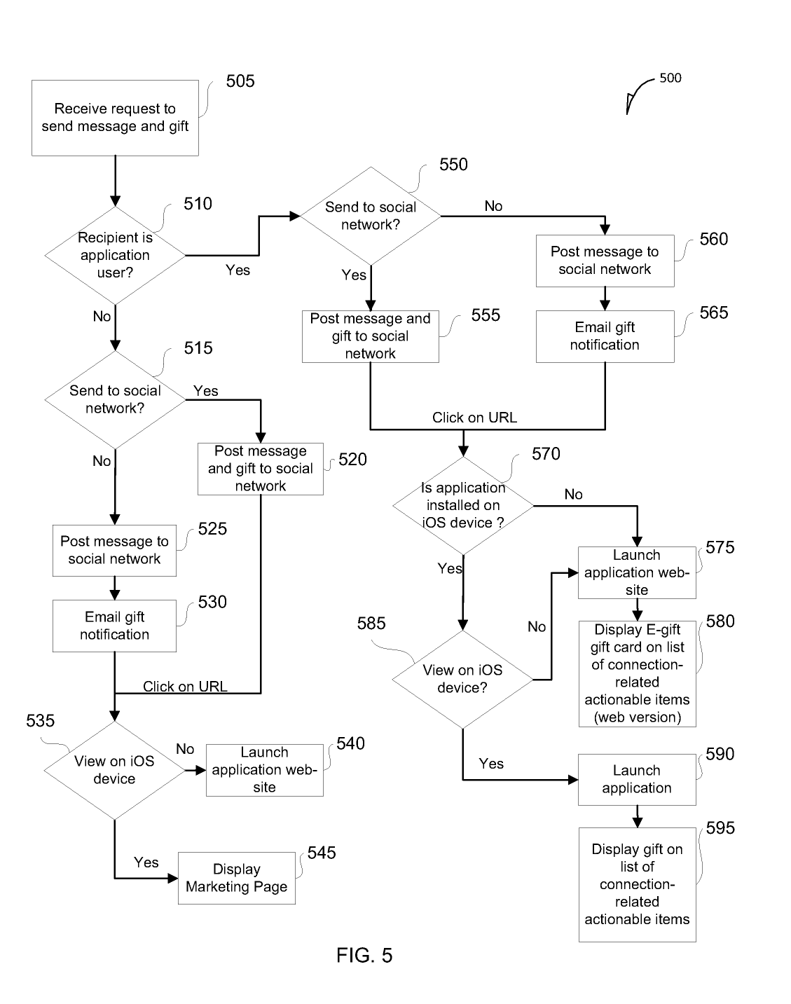

FIG. 5 is a flow chart detailing a method for sending and receipt of the event-triggered message and an associated E-gift card 500. The method may commence with receiving a request to send a message and a gift card at operation 505. At operation 510 it may be determined whether an intended recipient of the message and E-gift card is a user of the system/application for sending event-triggered messages and gifts to network users, and, if the intended recipient is the user of the system, at operation 550 the system may determine based on user-specified parameters, whether both the message and the E-gift card should be sent by to the social network 105, or whether the message and the E-gift card should be processed separately.

If the message and E-gift card need to be posted to the social network 105, the system may do so at operation 555. If the message and E-gift card should be processed separately, the message may be posted to the social network 105 at operation 560 and a notification informing the user about the E-gift card having been sent to the user may be sent to the email account of the user at operation 565. In both cases, when a link to the E-gift card is clicked, the system may determine at operation 570 whether the intended recipient has the system/application for sending event-triggered messages and gifts to network users installed on the iOS device of the intended recipient.

If the system/application for sending event-triggered messages and gifts to network users is installed on the iOS device of the intended recipient, at operation 585, the system may receive, from the intended recipient, a user request to show the E-gift card on the iOS device, launch the application on the iOS device at operation 590, and, finally, display the E-gift card on the list of the connection-related actionable items at operation 595.

If the intended recipient chooses not to view the E-gift card on the iOS device, the system may launch an application website at operation 575 and display the E-gift card on the list of the connection-related actionable items at operation 580.

If the intended recipient of the message and E-gift card is not a user of the system/application for sending event-triggered messages and gifts to network users, the system may determine, based on the user-specified parameters, whether both message and the E-gift card should be sent to the social network 105, or whether the message and the E-gift card should be processed separately.

If the message and E-gift card should both be posted to the social network 105, the system may do so at operation 520. When a corresponding link is clicked by the intended recipient, at operation 535, the system may determine whether the intended recipient may be shown some content, for example, a promotional page on the iOS device. If the intended recipient can be shown some content on the iOS device, the system may display the above content, for example, the promotional page, to the intended recipient at operation 545. If the intended recipient cannot be shown the content on the iOS device, the system may launch the application website at operation 540.

If, on the other hand, the message and E-gift card should be processed separately, the message may be posted to the social network 105 at operation 525 and a notification informing the user about the E-gift card having been sent to the user may be sent to the email account of the user at operation 530. When a corresponding link is clicked by the intended recipient, at operation 535 the system may determine whether the intended recipient may be shown some content, for example, a promotional page, on the iOS device. If the intended recipient can be shown the content on the iOS device, the system may display the above content, for example, the promotional page, to the intended recipient at operation 545. If the intended recipient cannot be shown the content on the iOS device, the system may launch the application website at operation 540.

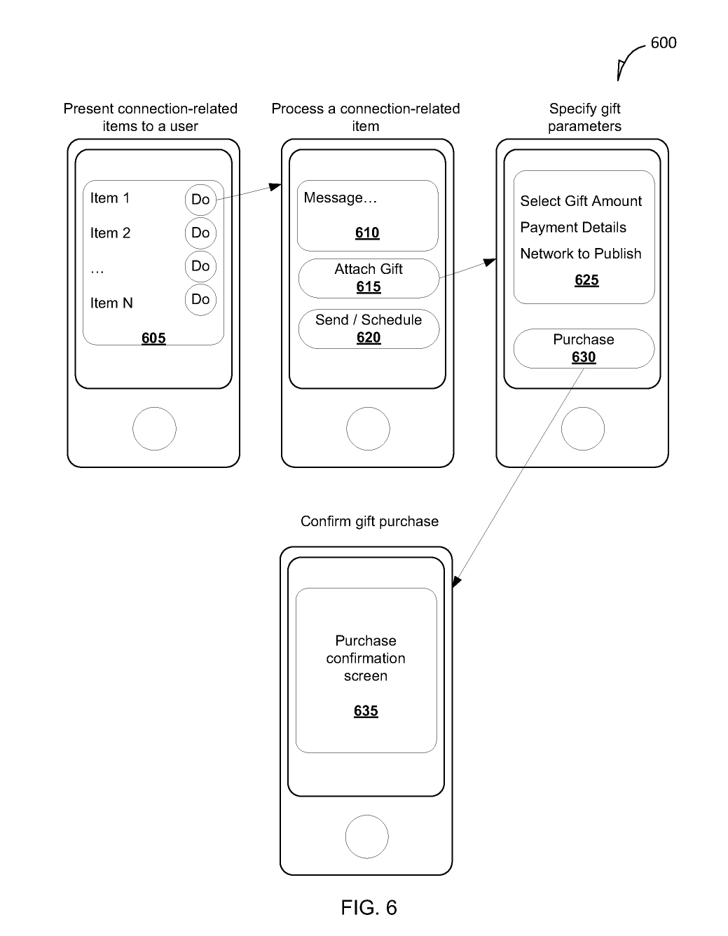

FIG. 6 is a sequence of example layouts, illustrating a method 600 for purchasing gifts and attaching them to greetings to be sent to users of social networks, in accordance with various exemplary embodiments. A screen 605 illustrates a list of the connection-related actionable items presented to the user. Each connection-related actionable item in the list may have an execution element (a “do” button), which transmits the user request to execute the connection-related actionable item and opens a connection-related actionable item processing screen.

The connection-related actionable item processing screen may contain a message box 610, an attach gift card button 615, and a send/schedule button 620. The message box 610 may be used to enter the greetings message to be sent to the connection. The attach gift card button 615 may be used to select the gift card to be attached to the greetings message, to specify parameters for the gift card selection and payment, and to purchase a selected gift card. The send/schedule button 620 may be used to send the greetings (if the connection-related actionable item refers to an event or activity that happens on the same day or already happened in the past) or to schedule sending of the greetings (if the connection-related actionable item refers to a future event or activity).

Selecting the attach gift card button 615 may display a gift card parameter specification screen, which may include gift card parameters 625 and a purchase button 630. The gift card parameters may have pre-populated values that correspond to the values the user has specified for a previous gift card. The pre-populated values may be edited by the user. Selecting the purchase button 630 may display a purchase confirmation screen 635, where the user may confirm the purchase, thereby requesting the execution of the purchase.

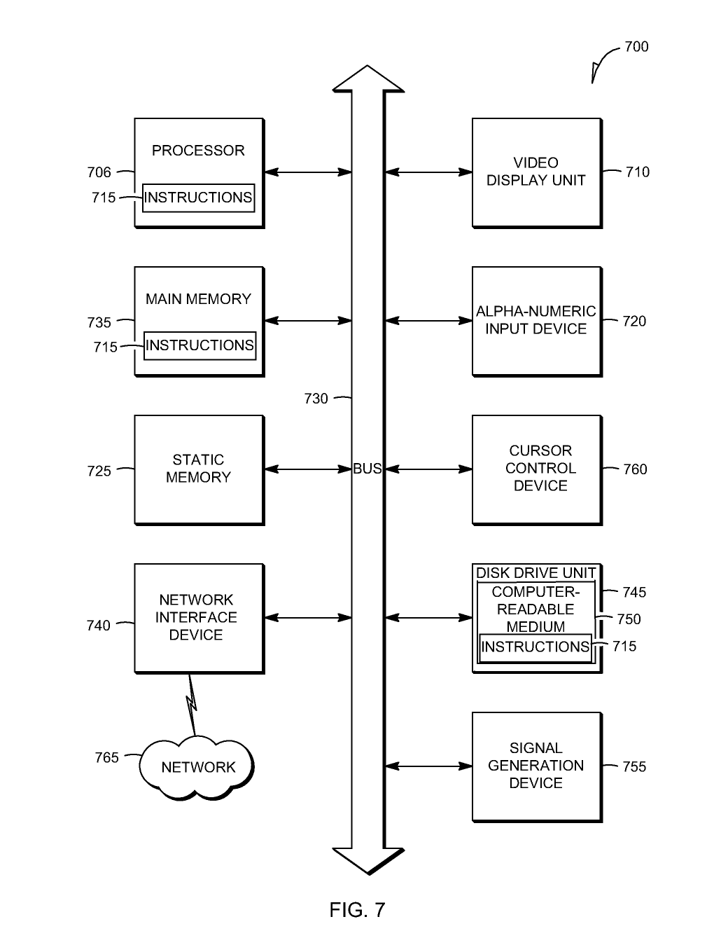

FIG. 7 is a diagrammatic representation of an example machine in the form of a computer system 700, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 705 (e.g., a central processing unit (CPU), a graphics processing unit (GPU), or both), and a main memory 735 and static memory 725, which communicate with each other via a bus 730. The computer system 700 may further include a video display unit 710 (e.g., a liquid crystal display (LCD)). The computer system 700 may also include an alpha-numeric input device 720 (e.g., a keyboard), a cursor control device 760 (e.g., a mouse), a voice recognition or biometric verification unit (not shown), a disk drive unit 745, a signal generation device 755 (e.g., a speaker) and a network interface device 740. The computer system 700 may further include a data encryption module (not shown) to encrypt data.

The disk drive unit 745 includes a computer-readable medium 750 on which one or more sets of instructions and data structures are stored (e.g., instructions 715), embodying or utilizing any one or more of the methodologies or functions described herein. The instructions 715 may also reside, completely or at least partially, within the main memory 735 or within the processors 705 during execution thereof by the computer system 700. The main memory 735 and the processors 705 may also constitute machine-readable media.

The instructions 715 may further be transmitted or received over a network 765 via the network interface device 740 utilizing any one of a number of the well-known transfer protocols (e.g., Hyper Text Transfer Protocol (HTTP)).

While the computer-readable medium 750 is shown in an example embodiment to be a single medium, the term “computer-readable medium” should be taken to include a single medium or multiple media (e.g., a centralized or distributed database or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks (DVDs), random access memory (RAM), read only memory (ROM), and the like.

The example embodiments described herein may be implemented in an operating environment comprising software installed on a computer, in hardware, or in a combination of software and hardware.

Although the embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A computer-implemented method for sending event-triggered messages and gifts to network users, the method comprising:
monitoring events associated with one or more user connections;
identifying the events associated with the one or more user connections that are suitable for generating one or more connection-related actionable items;
generating the one or more connection-related actionable items;
presenting the one or more connection-related actionable items to the user;
receiving a user request to execute the one or more connection-related actionable items; and
executing the one or more connection-related actionable items.

2. The computer-implemented method of claim 1, wherein the messages include one or more of a birthday wish, a greeting, and a gift.

3. The computer-implemented method of claim 1, wherein the events include one or more of a birthday, a marriage, winning a game, joining a user group, receiving a degree, getting promoted, making a purchase, and a company anniversary.

4. The computer-implemented method of claim 1, wherein receiving the user request includes receiving user instructions concerning a time and a manner in which the one or more connection-related actionable items are to be executed.

5. The computer-implemented method of claim 4, wherein receiving the user instructions further includes receiving information associated with purchasing and delivery of one or more gifts.

6. The computer-implemented method of claim 1, wherein the events are analyzed as to avoid generating duplicate connection-related actionable items.

7. The computer-implemented method of claim 1, wherein the one or more connection-related actionable items and gifts associated with the one or more connection-related actionable items are sent and received by a system for sending event-triggered messages and gifts.

8. The computer-implemented method of claim 1, wherein the one or more connection-related actionable items are executed substantially immediately upon request or in a future as scheduled by the user.

9. The computer-implemented method of claim 1, wherein parameters of the connection-related actionable items include one or more of a delivery date, payment details, a delivery channel, information on whether one or more related gifts have been purchased, and a name of social network that was used to generate the connection-related actionable item.

10. The computer-implemented method of claim 1, wherein the one or more connection-related actionable items pending execution is cancelled by the user.

11. The computer-implemented method of claim 1, wherein the method for sending event-triggered messages and gifts to network users is associated with a web-based or mobile application.

12. The computer-implemented method of claim 1, wherein the gift is an electronic gift card.

13. A computer-implemented method for sending event-triggered messages and gifts to network users, the method comprising:
creating, for one or more networks, a hierarchy of priorities in accordance with which events associated with one or more connections used to generate one or more connection-related actionable items;
establishing, for a selection of the connections from the one or more networks, the hierarchy of priorities in accordance with which the events associated with the connections used to generate the one or more connection-related actionable items; and
generating, for one or more user groups from the one or more networks, the hierarchy of priorities in accordance with which the events associated with the one or more connections used to generate the one or more connection-related actionable items.

14. A system for sending event-triggered messages and gifts to network users, the system comprising:
a monitoring module configured to monitor events associated with one or more user connections in one or more networks wherein a user is a member; and
an analysis and identification module configured to identify the one or more connections and suitable for generating one or more connection-related actionable items;
a presentation module configured to present to the user the one or more connection-related actionable items;
a communication module configured to receive a user request to execute the one or more connection-related actionable items; and
an execution module configured to execute the one or more connection-related actionable items.

15. The system of claim 14, wherein the analysis and identification module is further configured to:
generate the one or more connection-related actionable items;
purchase and deliver one or more gifts, and
receive the one or more connection-relate items and gifts

16. The system of claim 14, wherein the analysis and identification module is further configured to generate the one or more connection-related actionable items based on information associated with one or more of the following: a birthday, a marriage, winning a game, joining a user group, receiving a degree, getting promoted, making a purchase, and a company anniversary.

17. The system of claim 14, wherein the presentation module is further configured to present information to the user indicating one or more of the following: a delivery date, payment details, a delivery, information on whether one or more related gifts have been purchased, and a name of a social network that was used to generate the connection-related actionable item.

18. The system of claim 14, wherein the communication module is further configured to:
receive user instructions associated with purchasing and delivery of one or more gifts; and
instruct the execution module to execute the one or more connection-related actionable items.

19. The system of claim 14, wherein the analysis and identification module is further configured to execute the one or more connection-related actionable items with a delay specified by the user.

20. The system of claim 14, wherein the analysis and identification module is further configured to analyze events so as to avoid generating identical connection-related actionable items.

21. The system of claim 14, wherein the gift is an electronic gift card.

22. A non-transitory computer-readable medium having instructions stored thereon, which when executed by one or more computers, causes the one or more computers to:
monitor events associated with one or more user connections in one or more networks;
identify the events based on which one or more connection-related actionable items are generated;
generate the one or more connection-related actionable items;
present the one or more connection-related actionable items to user;
purchase one or more gifts;
attach the one or more gifts to greetings associated with the one or more connection-related actionable items;
receive a user request to execute the one or more connection-related actionable items; and
execute the one or more connection-related actionable items.
